(19) United States
(12) Patent Application Publication
(10) Pub. No.: US 2002/0069117 A1
(43) Pub. Date: Jun. 6, 2002

(54) Peer-to-peer electronic marketplace and systems and methods for conducting transactions therein

(76) Inventors: Christopher D. Carothers, Clifton Park, NY (US); Cheng Hsu, Latham, NY (US); David W. Bauer, Cohoes, NY (US)

Correspondence Address: HOFFMAN WARNICK & D'ALESSANDRO, LLC, 3 E-COMM SQUARE, ALBANY, NY, 12207

(21) Appl. No.: 09/728,539

(22) Filed: Dec. 1, 2000

(51) Int. Cl. G06F 17/60

(52) U.S. Cl. 705/26

(57) ABSTRACT

A peer-to-peer electronic marketplace and systems and methods for conducting transactions therein is provided. More particular, the electronic marketplace includes member systems and a market administrator. The market administrator controls the membership to a market of goods/services. Member systems communicate directly with each other using mobile agents without having to go through the market administrator. The mobile agents not only allow the users to remain anonymous, but also efficiently locate buyers and sellers of goods/services.

### BACKGROUND OF THE INVENTION

1. Technical Field

The present invention generally relates to peer-to-peer electronic marketplace. More particularly, the present invention relates to systems and methods for conducting transactions within an electronic marketplace.

2. Background Art

As use of the World Wide Web is becoming more prevalent, the demand to conduct transactions on-line is increasing. A common way to conduct online transactions with a business is to use the business' web site. However, online transactions could also take place in an electronic marketplace or exchange where many sellers and buyers meet to deal their goods/services simultaneously. When many sellers and buyers transact together, they typically undergo a “life cycle.” The whole process requires three steps: (1) identifying transaction opportunities (e.g., match, evaluation and contact); (2) executing the transaction process (e.g., offer and acceptance); and (3) completing the transaction (e.g., credit check, formalization and fulfillment of obligation). Thus, a full marketplace has to allow users to connect with each other directly (i.e., peer to peer), provide decision support throughout the “life cycle,” and integrate with other marketplaces (e.g., navigate to finance and shipment markets) if needed.

The related art is capable of providing only some of these services. One example is the eBay™ World Wide Web site, where a user can post a good/service for other users to bid upon. The user offering the highest bid is awarded with the posted good/service. The site functions as an exclusive hub—or, a central site—at which all dealings take place. It fails to provide direct person to person or buyer to seller transactions. Instead, the users must first post their offerings on the site without any decision support from the site (e.g., real time market information). Then, the transaction must be executed by and through the site. This not only limits the capability of the buyer and seller to negotiate and barter, but also reduces the capability to conduct transactions anonymously (e.g., without the eBay™ system or the other users knowing their identify). Another disadvantage of systems such as eBay™ is that users can only engage in transactions for the goods/services posted. Accordingly, a purchasing user must make separate independent searches, often through multiple systems, to locate other necessary goods/services. For example, if a user purchased one hundred pounds of meat from a selling user, the purchasing user may also need to arrange for delivery and financing of the meat. In related systems, the purchasing user may be forced to separately identify and purchase these complimentary services from other sources.

A second example is Commerce One™, which provides businesses with software to conduct electronic data interchange with other businesses. Companies would use the software to form their supply chains, or business circles around a hub site of a major buyer, or post businesses at a central site in a manner similar to eBay™. In both cases, the user companies transact with one another through a hierarchy of communication hubs linking their computer systems. This hierarchical structure of transactions limits the user companies' capability to connect directly with other companies. In other words, Commerce One™ types of systems still do not provide direct peer-to-peer markets. Furthermore, Commerce One™ caters mainly to processing information between computer systems (i.e., interoperation of enterprise processes and databases), as opposed to individual decision-makers conducting the transactions.

In all examples, the related art does not offer decision support and information services for users to support the whole “life cycle” of a transaction. For instance, the buyers or the sellers cannot offer a price based on the real time information from the market, or the true costs of the “life cycle” including all other related transactions on other markets pertaining to the deal. Moreover, they cannot barter based on preferences, profiles and past records of users. The related art also lacks necessary scalability to allow users moving from one market to another, so as to, for instance, extend the scope of trading or completing the transaction, without leaving the overall marketplace. In contrast, a full marketplace would allow knowledge workers to trade directly and anonymously, trade in monetary or bartering terms and participate in various markets in an integrated manner.

In view of the above, there exists a need for a system and method whereby buyers and sellers (as individual decision-makers) can directly conduct transactions with each other. There also exists a need for such a system and method to provide supporting information and services to the decision-makers throughout the life cycle of the transactions in the marketplace. In addition, the system and method needed should allow users to conduct the transactions anonymously. Moreover, a need exists for users to have the capability to directly negotiate and/or barter for goods and services. There is also a need for users to have the capability to be in communication with multiple markets to purchase complimentary goods and services. The system and method also needs to be scalable, allowing large amounts of users to use it simultaneous, with dynamic configuration (participation) of peers. Finally, there is also a need to allow the users to conduct transactions on the move—i.e., using mobile communications and computing devices to link to the system.

### SUMMARY OF THE INVENTION

The present invention overcomes the problems associated with existing systems by providing an electronic marketplace that facilitates the process for conducting online transactions. The system and method of the present invention allow a user to, among other things: (1) conduct transactions directly with each other on-line, without having to rely on a centralized system to facilitate the transaction; (2) identify one or more transaction opportunities with others in the electronic marketplace; (3) conduct such transactions anonymously; (4) barter and negotiate for goods and services; (5) simultaneously communicate with multiple markets to obtain complimentary goods/services; (6) receive online information and services to assist selling and buying decisions and other activities required of the transaction; (7) connect to large number of other users in an open arrangement; and (8) conduct transactions using mobile devices such as web-phones.

According to a first aspect of the present invention, an electronic marketplace is provided. The electronic marketplace comprises: (1) a plurality of member systems, wherein each member system includes a system for communicating transactional data with the other member systems; (2) a market administrator for supporting a transaction between a first member system and a second member system; and (3) wherein the transactional data communicated between member systems does not pass through the market administrator.

According to a second aspect of the present invention, a system for conducting transactions over an electronic marketplace including at least one member system is provided. Each member system comprises: (1) a member interface for inputting transactional data in a first format; (2) a converting system for converting transactional data between the first format and a market format; (3) a query generator for generating a query based on the transactional data; and (4) a routing system for directly communicating the query to at least one of a plurality of other member systems.

According to a third aspect of the present invention, a method for conducting transactions over an electronic marketplace is provided. The method comprises: (1) inputting transactional data in a first format; (2) converting the transactional data into a market format; (3) packaging the transactional data into a query; and (4) routing the query directly to at least one other member system.

According to a fourth aspect of the present invention, a program product stored on a recordable media for conducting transactions over an electronic marketplace is provided. The program product comprises: (1) a member interface for inputting transactional data in a first format; (2) a converting system for converting all transactional data between the first format and a market format; (3) a query generator for generating a query based on the transactional data; and (4) a routing system for communicating the query directly to at least one of a plurality of market systems.

According to a fifth aspect of the present invention, an electronic marketplace is provided. The electronic marketplace comprises a plurality of member routers each having at least one member system associated therewith, wherein each member router communicates directly with another member router based on routing information previously obtained from an administrator router.

It is therefore an advantage of the present invention to provide electronic marketplace and a system and method conducting transactions there over. It is also an advantage of the present invention to provide a system and method whereby buyers and sellers can directly and anonymously conduct transactions, negotiate and barter for the cost of goods/services, and directly obtain complimentary/ancillary services.

The preferred embodiment of the present invention is designed to solve the problems herein described and other problems not discussed, which are discoverable by a skilled artisan.

### BRIEF DESCRIPTION OF THE DRAWINGS

These and other features and advantages of this invention will be more readily understood from the following detailed description of the various aspects of the invention taken in conjunction with the accompanying drawings in which:

FIG. 1 depicts a block diagram of an architectural overview of a member system according to the present invention;

FIG. 2 depicts a first conceptual overview of an electronic marketplace;

FIG. 3 depicts a block diagram of a member system;

FIG. 4 depicts a block diagram of a market administrator;

FIG. 5 depicts a second conceptual overview of an electronic marketplace;

FIG. 6 depicts an architectural overview of an electronic marketplace; and

FIG. 7 depicts a flow chart of a method according to the present invention.

It is noted that the drawings of the invention are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE DRAWINGS

For convenience, the description includes the following sections:

I. Definitions

II. Computer System

III. Electronic Marketplace

A. Conceptual Overview

B. Member System Operations

C. Market Administrator

D. Second Conceptual Overview

E. Architectural Overview

IV. Method

I. Definitions

For the purposes of this disclosure, the following terms have the following meanings:

User—a buyer or seller of good/services who transacts through an electronic marketplace of the present invention.

Purchasing Member System—a member system that is purchasing goods/services.

Purchasing User—a user of a member system that is purchasing goods/services (e.g., a restaurant).

Selling Member System—a member system that is selling goods/services.

Selling User—a user of a member system that is selling goods/services (e.g., a butcher).

Transaction—the buying or selling of a good/service between member systems.

Market Administrator—a system that administers a market for particular goods/services (e.g., nuts and bolts) or for a class of goods/services (e.g., hardware).

Market Credit—a form of currency that can be used to secure the purchase of goods/services in the electronic marketplace.

Member—a member system that has membership in a particular market

Member System—a group of sub-systems/resources used to buy or sell goods/services.

Transactional Element—a proposal, offer, counter-offer or acceptance communicated from one user to another

II. Computer system

Generally stated, the present invention provides an electronic marketplace for directly conducting transactions over a network, such as the World Wide Web. Specifically, the electronic marketplace of the present invention includes member systems and at least one market administrator/system configured to allow users to conduct on-line transactions directly with each other in a secure environment.

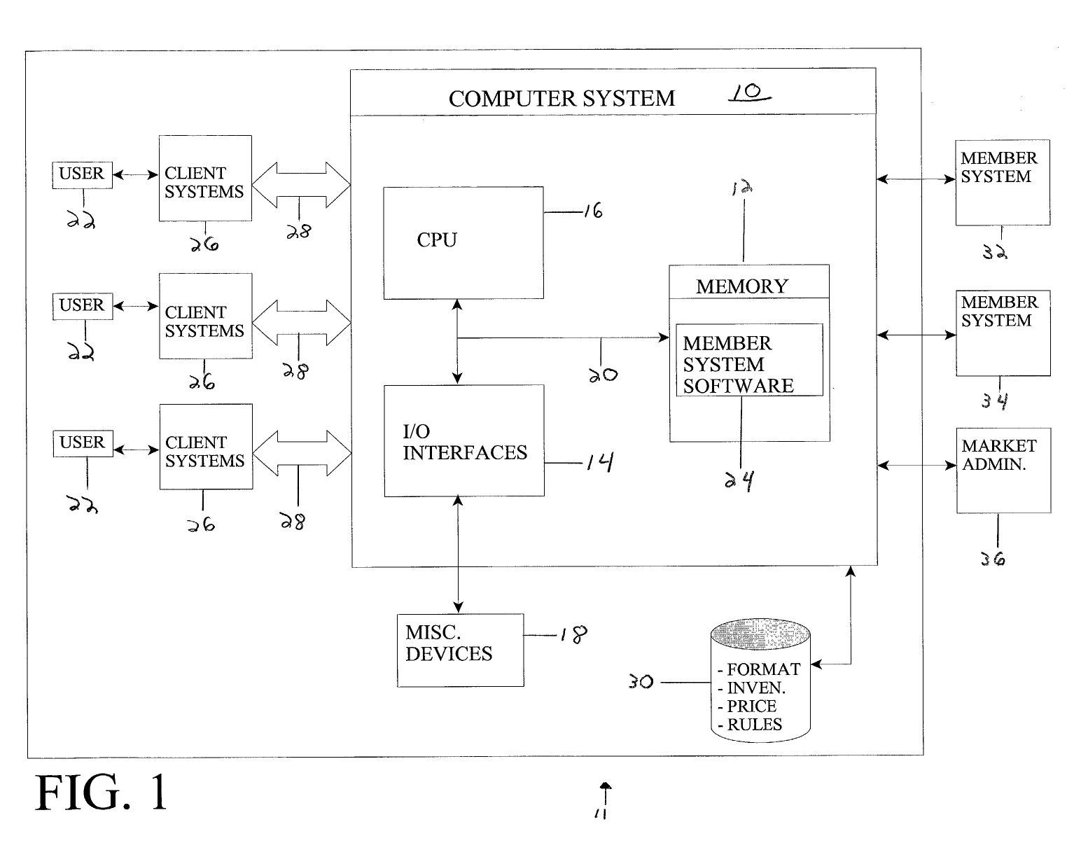

Referring now to FIG. 1, and architectural overview of a member system 11 is shown. The member system 11 generally comprises a computer system 10, users 22 and client systems 26. Computer system 10 generally comprises memory 12, input/output interfaces 14, a central processing unit (CPU) 16, miscellaneous devices/resources 18, and bus 20. Memory 12 may comprise any known type of data storage and/or transmission media, including magnetic media, optical media, random access memory (RAM), read-only memory (ROM), a data cache, a data object, etc. Moreover, memory 12 may reside at a single physical location, comprising one or more types of data storage, or be distributed across a plurality of physical systems in various forms. CPU 16 may likewise comprise a single processing unit, or be distributed across one or more processing units in one or more locations, e.g., on a client and server.

I/O interfaces 14 may comprise any system for exchanging information from an external source. Miscellaneous devices 18 may comprise any known type of computer resource, including a server and routing hardware, a CRT, LED screen, hand held device, keyboard, mouse, voice recognition system, speech output system, printer, facsimile, pager, personal digital assistant, etc. Bus 20 provides a communication link between each of the components in the computer system 10 and likewise may comprise any known type of transmission link, including electrical, optical, wireless, etc. In addition, although not shown, additional components, such as cache memory, communication systems, system software, etc., maybe incorporated into computer system 10.

Stored in memory 12 is member system software. Member system software 24 will be described in more detail below but generally comprises various sub-systems for enabling users to conduct transactions within an electronic marketplace. Database 30 may store data necessary to engage in transactions, e.g., the users' product/service inventory, pricing information, a table that correlates the users' own unique product/service nomenclature to a standard marketplace terminology and transaction rules. Moreover, database 30 may comprise one or more storage devices, such as a magnetic disk drive or an optical disk drive. In another preferred embodiment, database 30 includes data distributed across, for example, a local area network (LAN), wide area network (WAN) or a storage area network (SAN) (not shown). Database 30 may also be configured in such a way that one of ordinary skill in the art may interpret it to include multiple databases.

A user 22 seeking to conduct an on-line transaction will utilize a client system 26 (i.e., web browser) and communications network 28 to access and the computer system 10. Communications network 28 can be a direct terminal connected to the server system 10, or a remote workstation in a client-server environment. In the case of the latter, the client and server may be connected via the Internet, wide area networks (WAN), local area networks (LAN) or other private networks. The server and client may utilize conventional token ring connectivity for WAN, LAN, or other private networks, or Ethernet, or other conventional communications standards. Where the client is connected to the system server via the Internet, connectivity could be provided by conventional TCP/IP sockets-based protocol. In this instance, the client would utilize an Internet service provider outside the system to establish connectivity to the system server within the system. Accordingly, it should be understood that users 22 can access the computer system 10 from any device capable of Internet connectivity. For example, the users 22 could connect to the computer system 10 via a wireless device (e.g., personal digital assistant, pager device, cellular telephone, etc.) or a computer workstation.

Depending on the situation, users will either directly control a transact process via computer system 10, or the member system software 24 itself will control the transactional process. Member system software 24 in general provides: (1) a system for identifying transactional opportunities with other member systems 32 and 34; (2) a system for engaging in a transactional process with another member system 32 and/or 34; and (3) a system for interfacing with a market administrator 36 to, e.g., clear a completed transaction. Although not shown, market administrator 36 may comprise a similar architecture as that shown for member system 11, except that it contains market administrator software, which is described in more detail below.

It is understood that the present invention can be realized in hardware, software, or a combination of hardware and software. As indicated above, the computer system 10 according to the present invention can be realized in a centralized fashion in a single computerized workstation, or in a distributed fashion where different elements are spread across several interconnected computer systems (e.g., a network). Any kind of computer system or other apparatus adapted for carrying out the methods described herein is suited. A typical combination of hardware and software could be a general purpose computer system with a computer program that, when loaded and executed, controls the computer system 10 such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods described herein, and which when loaded in a computer system is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material document.

III. Electronic Marketplace

A. Conceptual Overview

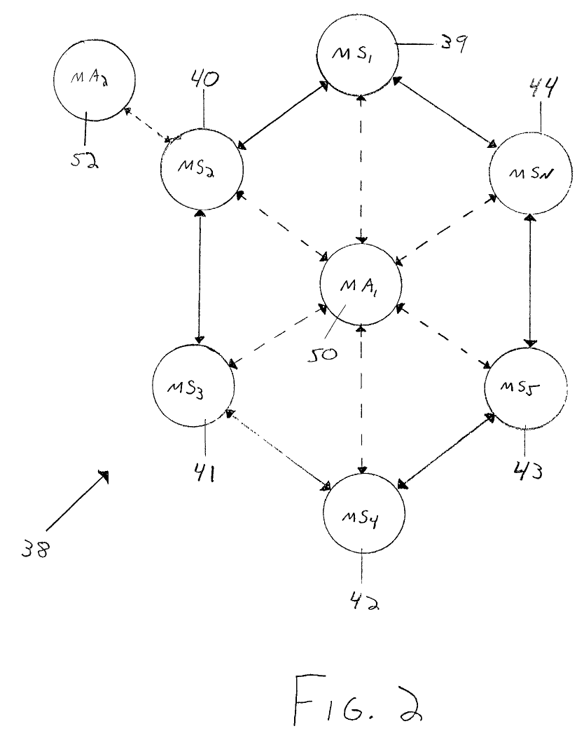

Referring now to FIG. 2, a conceptual overview of an electronic marketplace 38 is shown. As depicted, the electronic marketplace 38 includes member systems 39-44 and market administrator 50. Each member system 39-44 comprises a router system that allows communications among all of the other member systems without having to interact with the market administrator 50. Thus, member system 40 can transact with member system 42 without having to communicate through market administrator 50. For example, if member system 40 desired to purchase one hundred pounds of meat, the member system 40 would submit a proposal, which would be routed to the other member systems 39 and 41-44 to identify potential transaction opportunities. The member systems 39 and 41-44 could then elect to engage in a transaction by making an offer to member system 40.

The offer(s) would be routed back to the member system 40, which could chose to reject the offer(s), negotiate with a particular member system, or accept a particular offer. Once accepted, the transaction is completed. The completed transaction could then be communicated to the market administrator 50, which would clear the transaction and update its database concerning, e.g., the market status, member accounts (including possibly bartering credits), and system data. The process of clearing the transaction may involve: (1) checking the credit of the purchasing member system; (2) arranging payment between the member systems; (3) generating a packing slip, etc. Purchasing member system 40 could then arrange payment with the selling member system in any number of ways. Specifically, the purchasing member system 40 may use currency, barter, or purchase the meat based on previously “banked” market credits, as stored and managed by the market administrator 50. In addition to clearing transactions, the market administrator 50 controls membership and security for the particular market (in this example the meat market). For example, when member systems 39-44 first desired to participate in the meat market, their membership had to be administered by the market administrator 50. This may require the member systems 39-44 to provide, among other things, member information and/or credit information so that integrity of the marketplace 38 can be maintained. Once joined, the market administrator 50 provides a member system with member system software and adds the member system to the router network. Market administrator 50 also maintains the router network by updating the member system's software as required (as will be discussed in further detail below).

Each member system 39-44 (or the users thereof) may also be required to deposit currency (e.g., cash, check, credit card, etc.) with the market administrator 50 to guaranty future purchases. For example, member systems 39-44 may have to provide $1000 upon joining the meat market and then be allotted $1000 worth of market credits for future purchases. Accordingly, if member system 40 purchased one hundred pounds of meat from member system 44 for $500, member system 40 may make payment based on its credits. In such a case, the market administrator 50 could re-allocate $500 worth of market credits from member system 40 to member system 44, or could just issue member system 44 $500 in currency.

By maintaining credit and member information in a central location apart from the other member systems, the market administrator 50 maintains anonymity and integrity of transactions. Specifically, the member systems 39-44 would not be given access to the credit and member information for other member systems.

As further shown in FIG. 2, member system 40 is also in communication with a second market administrator 52 (corresponding to a second market), which may be un-related to the meat market. For example, market administrator 52 may be a part of a shipping and distribution market. Therefore, upon completion of the purchase of the meat, the purchasing member system 40 may use the same procedure, via the shipping and distribution market, to secure the delivery thereof.

The way by which the market administrator 50 can similarly be a part of other markets is two-fold: (1) the market administrator 50 registers with the market administrator 52 of the other market; and (2) the market administrator 50 uses the same communication and interfacing methods as described for this market to transmit the member system's 40 requests to the members and administrators of other markets.

In addition to anonymity, efficiency and security, the present invention also provides real-time price evaluation for business. For example, if a meat retailer buys meat in a meat market, sells in a restaurant food supply market, and arranges shipping through a shipping market, it could use the real time information from all three markets concerning a particular transaction to determine its real cost and thereby set the most competitive price for the transaction. The access to market information on a real time and online basis reduces the lag business often experience in adjusting their selling prices to reflect their costs.

B. Member System Operations

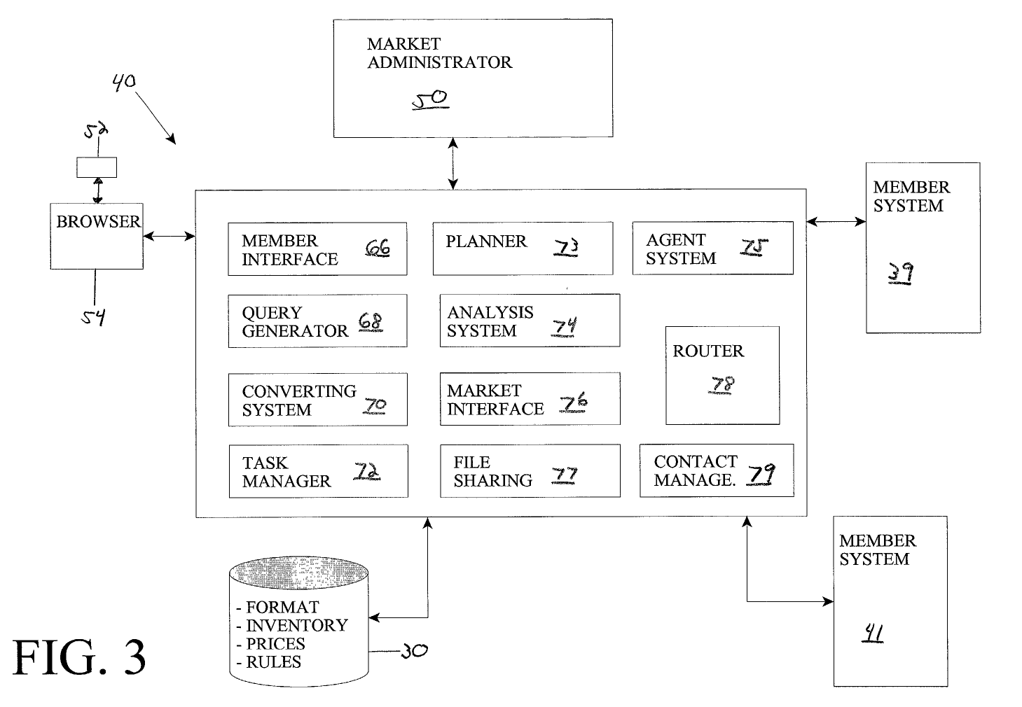

Referring now to FIG. 3, the functional features of member system 40 are shown in greater detail. As depicted, the functional features include member interface 66, query generator 68, converting system 70, task manager 72, planner 73, analysis system 74, agent system 75, market interface 76, file sharing system 77, router 78 and contact management system 79. Member system 40 is in communication with market administrator 50, member system's 40 own enterprise database 30 and member systems 39 and 41 (the other member systems 42-44 and market administrator 64 are not shown for simplicity purposes). It should be appreciated that although member system 40 is shown to be in direct communication with only two other member systems 39 and 41, any other number of member systems may be included in the marketplace.

Member interface 66 provides a mechanism for user 52 to engage in a transaction with the marketplace. Thus, if purchasing user 52 wanted to purchase one hundred pounds of meat, he/she would use browser 54 to communicate transaction details. Specifically, using the member interface 66, the purchasing user 52 would input transactional data for a proposal (e.g., to purchase one hundred pounds of meat). The transactional data can include any transactional parameters desired by the user. For example, the transactional data can include e.g., a product type, a quantity, a price, etc. In addition, the transactional data could include special requirements or conditions.

The member interface 66 uses a standard protocol to allow different computer systems market documents and other software objects over the Internet. Preferably, the standard protocol is an Extended Mark-up Language (XML) interface. The software programs, transactional files, and other objects that the member systems and the administrator system need to transmit among them will be embodied in the XML code and processed.

Once the transactional data has been inputted, the query generator 68 will convert the data into a query representative of a transactional element. Specifically, the data inputted must be put into the form of a proposal, an offer, counter-offer or an acceptance that can be recognized by other member systems. In this example, the query is a proposal query (i.e., the purchasing user 52 is seeking offers from pork chop selling users). Preferably, query generator utilizes a Standard Query Language (SQL) interface that places the transactional data inputted into a format that can easily be routed to and universally recognized by other member systems.

Converting system 70 provides a mechanism for interpreting communications among member systems to achieve a common meaning of data for all users. For instance, it converts the nomenclature of a particular member system to a common or marketplace standard naming format, and vice versa. In particular, since each member system may use unique nomenclature to referring to their goods/services, the transactional data inputted may have to be converted to a common format. For example, member system 40 may indicate pork chops with the letters “PK” whereas other member systems 49 and 41-44 may indicate pork chops as “PRK.” Moreover, a market standard, as determined by the market administrator 50, may indicate meat entirely differently (e.g., PCHOPS). To overcome this, each member system is required to provide a format table or the like in its enterprise database 30 that correlates its products/services to the market standard nomenclature. The converting system 70 will access the table to convert the transactional data to the market standard format.

It should be appreciated that the conversion of the transactional data may take place at any point prior to its routing to other member systems (e.g., before or after query generation) and the order of events described herein is for illustrative purposes only. Moreover, it should be understood that the enterprise database 30 may be maintained by the member system 40 and be accessible by all users of member system 40. Alternatively, each user may maintain his/her own database, which member system 40 can access as needed.

Once the query has been generated, it will be passed to a router 78 for routing to other member systems. The router 78 preferably includes routing information that identifies other member systems communicating with the market so that it knows where to send the query. This routing information is obtained from the market administrator 50 via market interface 76. The router sends and receives queries using mobile agents so that each or any specified member system can receive the query.

Mobile agents are well known in the art. Generally, a mobile agent is a software program that a first computer system sends to a second for processing. The first computer system owns and maintains the software program while the second executes the program. A mobile agent carries out activities in a flexible and intelligent manner and is responsive to changes in environment without requiring constant human guidance. Specifically, the mobile agents may have the following attributes set forth in the book entitled Software Agents edited by Jeffrey M. Bradshaw, American Association for Artificial Intelligence, MIT Press, 1997, Cambridge, Mass.:

Reactivity: The ability to sense and act;

Autonomy: The agent has goals, is self-directed and is proactive in achieving the goals;

Collaborative Behavior: The agent can work in concert with other agents to achieve a common goal;

Temporal Continuity: The agent maintains it's identity and state over extended periods of time;

Adaptivity: The agent can learn and improve with experience; and

Mobility: The agent is capable of migrating in a self-directed way from one host platform to another.

Preferably, the mobile agents are constructed using the Erlang programming language by Ericsson. However, it should be appreciated that other programming languages such as C, C++, JavaScript, Java, etc. could be implemented. Erlang is a run-time environment, which allows for millions of independent, lightweight processes, each capable of mobility in a distributed environment. This allows for millions of mobile agents to be spawned on an inexpensive, off the shelf PC. These agents may remain in one market or may move to other markets via the Internet. Once moved to a new market, the agents can continue working autonomously.

Erlang also provides active code, which will allow agents to transform themselves in order to complete the different tasks or to behave properly in different environments. Active code is the ability for a process to rebuild its underlying code, while still acting in its environment. Because Erlang was designed to work in a distributed environment, markets created with Erlang will have little or no deficiencies in communicating over the Internet.

Erlang also provides many other functions that other current markets lack. These include: a real-time environment where the system will respond in a specific period of time; continuous operation so that the markets can operate nonstop; distribution so that exchanges can be scaled to work from a single machine to an entire network of machines; and integration so that markets can work with other types of software.

In the example above, mobile agents take the proposal for pork chops and search each member system/enterprise database for transactional opportunities that can fulfill the purchasing user's proposal. Accordingly, a member system or a purchasing user 52 is not forced to directly query each other member system and can remain anonymous. Moreover, since the market administrator 50 maintains the routing information for the entire marketplace, the member systems do not need to maintain lists of other member systems or users thereof.

The agents are stored and maintained in the agent system 75. They include search agents, buying agents and selling agents, among others. These agents are in general provided by the market administrator 50 when the user first registers, and maintained thereafter as long as the user stays with the marketplace. However, the users could also provide their own agents according to the standard protocol of the marketplace. When changes (addition, deletion, or modification) are made either to agents or to the standard way agents are deployed, the market administrator 50 will update the agent system 75 of all member systems to maintain the technical integrity of the marketplace. This is an important feature of the present invention, since the amount of agents may be very large when the number of users of a marketplace is large. In particular, the present invention provides a method to create and maintain large amount of agents with practically acceptable cost and speed.

As indicated above, the other member systems, including those not shown in FIG. 3, have the same sub-systems that are shown for member system 40. Accordingly, as the proposal query is received, each receiving member system will access a database to convert from the market format to its own format. The selling member systems can then choose to make an offer to sell based on the proposal, make a counter-offer or not to respond at all. To make an offer, the selling member system would input transactional data with the details of the offer and send it back to the original member system using mobile agents. However, similar to the proposal query, the offer transactional data must first be converted from the seller's format to the market format, and packaged into a query (i.e., an offer query). The offer query is then sent via a router back to the purchasing user's member system 40.

Once the offer query is received by the member system 40, it will be converted from the market format to the purchasing member system's format. The purchasing member system can then accept or reject the offer, or negotiate with a counter-proposal. User 52 may make the decision by entering transactional data corresponding to the purchasing user's choice. Alternatively, analysis system 74 can be utilized to provide an automated determination and response without relying on user 52 (as will be discussed below). Similar to the above communications, any responsive transactional data is converted to the market format by converting system 70 and packaged into a query (e.g., acceptance, rejection, counter-offer) by query generator 68.

As indicated above, the analysis system 74 allows for automated analysis and creation of queries. Specifically, the member system 40 could use previously established rules in processing and responding to queries. For example, a purchasing member system can configure the analysis system 74 to interpret any incoming queries and accept the best offer. Alternatively, the analysis system 74 may be set to present all offers to the purchasing member system in a predetermined format (e.g., chronological order, best price first, etc.). Moreover, the analysis system 74 can be configured to automatically respond to proposals. For example, selling member systems could set the analysis system to respond to proposals to purchase pork chops with the price and quantity stored in their database. Thus, if the database for the selling member system indicated an available inventory of one hundred pounds of meat for $2 a pound, the analysis system 74 would automatically generate an offer of $200 in response to a proposal to purchase one hundred pounds of meat. Moreover, the analysis system 74 could be configured to send a proposal query for a specific product if inventory falls below a certain level. Rule-based configuration will allow the user and the member system to rapidly shift from one mode of operation to another. To achieve this capability, the member systems could use a standard table format to represent rules and store them in the enterprise database 30. Similarly, the market administrator 50 maintains necessary data about these rules and tables, so that it can facilitate maintaining and coordinating these rules, if needed. The analysis system 74 reads these rules to interpret its operating rules.

Task manager 72 helps identify and coordinate other goods and services that are complimentary to a transaction. For example, if a purchasing member system accepted an offer to buy one hundred pounds of pork chops, the task manager 72 could automatically arrange financing or delivery for the meat from different marketplaces. The task manager 72 identifies such other services for the purchasing member system and may then procure the services from other markets (of which the purchasing member system is also a member).

Member system 40 can also include a planner 73 to provide the capability to schedule transactions and agents from a calendar perspective. Through the planner 73, mobile agents will be able to process asynchronous transactions. A mobile agent, upon completion of a specified task, will report back to the member system 40 through the planner 73. The user can choose to have the agent complete further tasks or decide that the tasking is complete. Similar to the other aspects of the member system 40, user 52 will also be able to communicate with the planner 73, via member interface 66 from any Internet capable device (e.g., wireless).

File sharing system 77 provides member system 40 with the capability to share files with other member systems 39 and 41. Specifically, member system 40 could maintain at least three different types of files: public, private, and commercial. Public files are available and searchable by any other member system. Private files are available and searchable only by member systems having “permission.” Accordingly, file sharing system 77 may include a permission assignment system for identifying other member systems and assigning passwords thereto. Commercial files are available and searchable like public files. However, to obtain/copy commercial files, a payment must be made. The file sharing system 77 allows all member systems to share or exchange documents, such as contracts, bids, proposals, technical data, etc. It should be appreciated, however, that although file sharing system 77 is described in conjunction with member system 40, certain functionality could exist at the market administrator level 50, as will be further described below.

Contact management system 79 allows member systems to build a list of contacts of other member systems. The list of contacts could be used to identify member systems for future transactions. The list can also be made available to other member systems through the file sharing system 77. Moreover, contact management system 79 allows member systems to designate groups of other member systems and assign permissions to each group. For example, member system 40 may create two groups of member systems. One group may have access to member system's 40 private files, while the other may not.

It should be understood that although a particular configuration for the member systems have been depicted and described other variations exist. For example, the router 78 and query generator 68 and converting system 70 could be depicted as one system.

C. Market Administrator

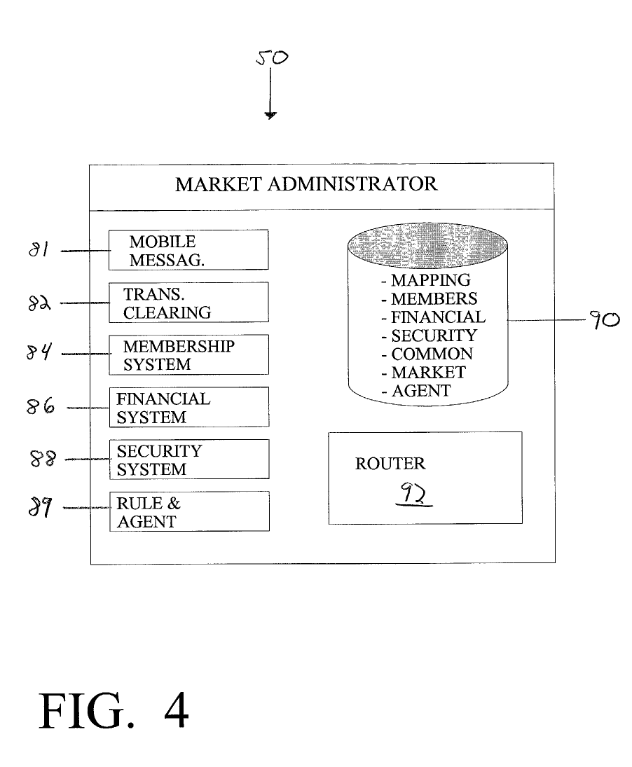

Referring now to FIG. 4, a more detailed depiction of the market administrator 50 is shown. Similar to the above description of member system 40, the description given for the market administrator 50 applies to all market administrators depicted and described herein. Market administrator 50 preferably includes mobile messaging system 81, transaction clearing system 82, membership system 84, financial system 86, security system 88, rule and agent management system 89, database 90 and router 92.

The mobile messaging system 81 is optional and uses a standard mobile protocol, such as WAP, to send and receive messages in a predetermined mobile communication network. This allows users to gain access to their own member systems through the market administrator and conduct transactions thereby. The processes for conducting transaction in the electronic marketplace after the mobile connection with the market administrator is established is the same for both mobile and fixed users. Specifically, once connected, transactions are conducted directly between member systems, without having to communicate through the market administrator.

Transaction clearing system 82 is initiated upon completion of a transaction between member systems. Specifically, once member systems have agreed upon terms of a transaction, the transaction clearing system 82 will clear the transaction and update marketplace data. This may include credit checking, generating purchase orders and/or packing slips, identifying member systems, etc.

The membership system 84 is responsible for administering member systems, including, admitting new member systems, providing member system software and updating member systems (e.g., routing information), etc. For example, if an entity wants to become a member of the meat market, they may be required to input their member details, e.g., contact information, tax/credit information, banking information, etc. Some market administrators 50 may also require all prospective members to pass a credit check prior to be granted membership privileges. As indicated above, the centralized storage of this information by the market administrator 50 helps maintain integrity and security for the market.

Financial system 86 keeps track of the member system's market credits and currency. In the case of bartering, it could also maintain the chosen system of bartering credit, such as some common measures of exchange. As indicated above, member systems may be required to deposit a pre-determined amount of currency during their membership. In exchange, they would be apportioned a commensurate amount of market credits. Thus, when purchasing goods/services from other member systems, the purchasing member system could pay for the purchase using market credits. The financial system 86 would keep track of member systems' balances, in conjunction with the database 90, and transfer funds to selling member systems. Transfer could occur by transferring the agreed upon amount in credits from the purchasing member system's account to the selling member system's account or by sending actual currency to the selling member system. It should be understood that use of the financial system 86 might be optional. For example, a purchasing member system may arrange for payment directly to the selling member system, the member systems may directly barter for the goods/services, or the purchasing member system could obtain financing for the purchase through another market.

The financial system 86 could also be used in conjunction with agent management system 89 (described in further detail below) to “hire” mobile agents for transactions outside of the marketplace. For example, if member system 40 desires to purchase a compact disk player, but is not a member of an electronic market, member system 40 could hire a mobile agent to search for purchasing opportunities. The fee for hiring the mobile agent as well as payment for the transaction could be arranged using the member system's 40 stored market credits.

The security system 88 is responsible for maintaining user security information (e.g., passwords, user names, etc.) so that only approved member systems can conduct transactions over the market. This information could be stored in the database 90 where it remains confidential so that transaction can be conducted anonymously. The information is referenced upon completion of a transaction in conjunction with the transaction clearing system 82.

The rule and agent management system 89 is responsible for the maintenance/management of members' agent system 75 and the rules used in the analysis system 74, both of which are described above in the member system 40. The rule and agent management system 89 will embody the changes (e.g., addition, deletion, or updates to agents and rules) in a standard format for the market interface 76 to interpret, which, in turn, passes the result to the agent system 75 and the analysis system 74 of member system 40. It will also be capable of sending new software programs used in the member systems.

The router 92 functions like the routers of the member systems 39-44 by passing communications to the member systems 39-44. Similar to the member systems, mobile agents are utilized to allow all transactions to remain anonymous and convenient for the users. The administrator database 90 not only stores membership, financial and security information, but also contains routing information that is provided to by each router of the member systems 39-44. As indicated above, the routing information directs the member system routers where to send queries. Specifically, the routing information provides the member system routers with the identifies/locations of other member systems (routers) that are in communication with or participate in the market. Also stored in the database is data pertaining to rules and agents, such as their structuring, deployment, and management in member systems, and common information. Common information may pertain to general market conditions, reports or any information that is not deemed private by any user. Users can access this information via the market interface 76 of their respective member systems. As indicated above, each member system may include a file sharing system 77 for sharing files of each member system or user. The database 90 may include an index or the like of files that are available for sharing for each member system. A member system seeking a particular file (e.g., a contract) could access the database 90 and index via their market interface 76. Using the index, the member system could identify other members systems where the desired is stored.

D. Second Conceptual Overview

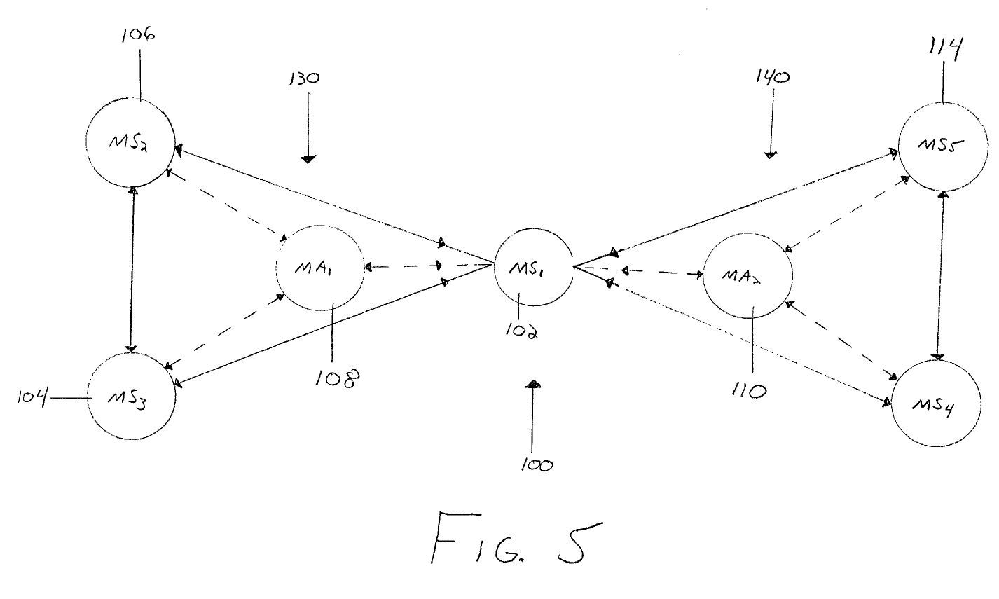

Referring now to FIG. 5, a second conceptual diagram of an electronic marketplace 100 according to the present invention is shown. It should be appreciated that the market systems and market administrators described in conjunction with FIG. 5 have the same sub-systems and function in the same manner as those described in conjunction with FIGS. 1-4.

FIG. 5 depicts a marketplace 100 that comprises two markets 130 and 140. As depicted, member system 102 is a member of both markets 130 and 140, which are administered by market administrators 108 and 110, respectively. This shows that a member system 102 can be a member of, or in communication with more than one market (e.g., the meat market and distribution market) at the same time. For example, if member system 102 desired to purchase one hundred pounds of pork chops from the meat market 130, the member system 102 would create a proposal query. Then, as described above, the proposal query would be routed (in market format) to the other member systems 104 and 106 of the meat market 130. The potential selling member systems 104 and 106 could then send an offer back to the purchasing member system 102, which could accept, reject or make a counter-offer.

Assuming an offer was accepted and the transaction completed, the selling member system may need to secure delivery for the meat. Accordingly, a proposal query could immediately be sent over the distribution market 140. A selling member system 114 in the distribution market 140 could similarly make an offer, which the purchasing member system 102 is free to accept. The task manager (not shown) of the purchasing member system 102 could be programmed to automatically seek ancillary or complimentary services that are necessary for a purchase. For example, the purchasing member system 102 may program the task manager that delivery must be procured upon acceptance of any offer. Accordingly, upon acceptance of the meat selling member system's offer, an automatic reminder could be sent to the purchasing member system to query the distribution market. Such a reminder can be sent to the purchasing member system 102 via e-mail or can be available at the member interface 66 (not shown). It should be understood that the task manager can work similarly for all member systems, not just purchasing member systems. For example, a selling member system may be reminded to purchase more inventory upon selling a particular quantity of goods/services.

E. Architectural Overview

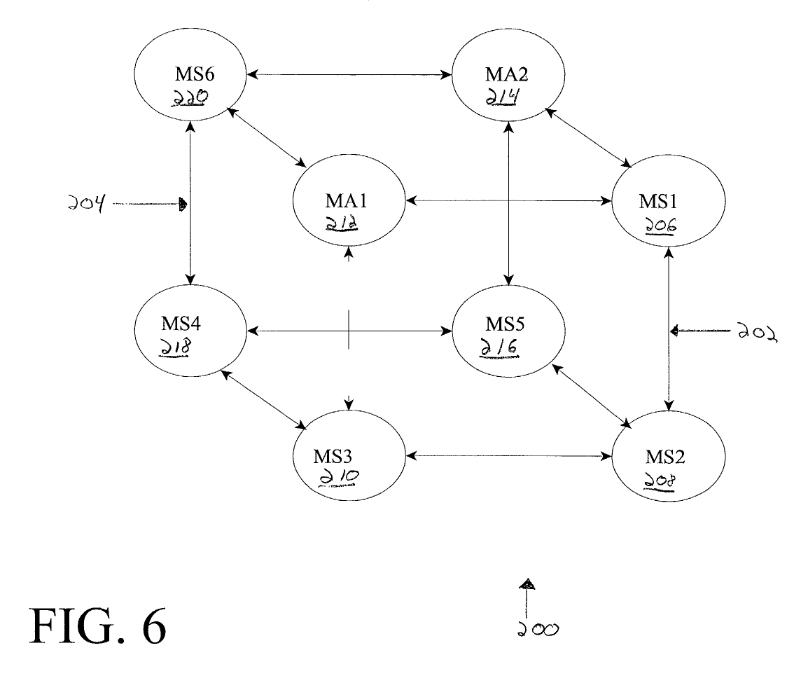

FIG. 6 depicts a generic architectural overview an electronic marketplace 200 according to the present invention. It should be appreciated that the member systems and market administrators described in conjunction with FIG. 6 have the same sub-systems and function in the same manner as those described in conjunction with FIGS. 1-5. For example, member systems 206, 208, 210, 216, 218 and 220 obtain routing information from market administrators 212 and 214.

As shown, the electronic marketplace 200 takes the form of a hypercube having eight nodes or router systems that communicate as described above in conjunction with FIGS. 1-5. Specifically, the router systems comprise member systems 206, 208, 210, 216, 218 and 220 and market administrators 212 and 214. Two market administrators 212 and 214 are shown to demonstrate that the electronic marketplace 200 can include multiple markets 202 and 204 (e.g., meat and distribution). However, it should be understood that the marketplace 200 could be implemented with only one market and thus, one market administrator. For example, market administrator 214 could be another member system. In such a scenario, the market 202 would comprise seven member systems and one market administrator.

By implementing the routers in a hypercube format, each member system need only connect with a limited number of other systems. In particular, the relationship between connections “C” and router systems “S” is given by the equation: S=2^{c}. In the case depicted, eight systems are provided (S=8). Thus, each router system need only be aware of, or connected to three other systems (C=3) in order to function in the electronic marketplace 200. This feature helps provide anonymity among members.

IV. Method

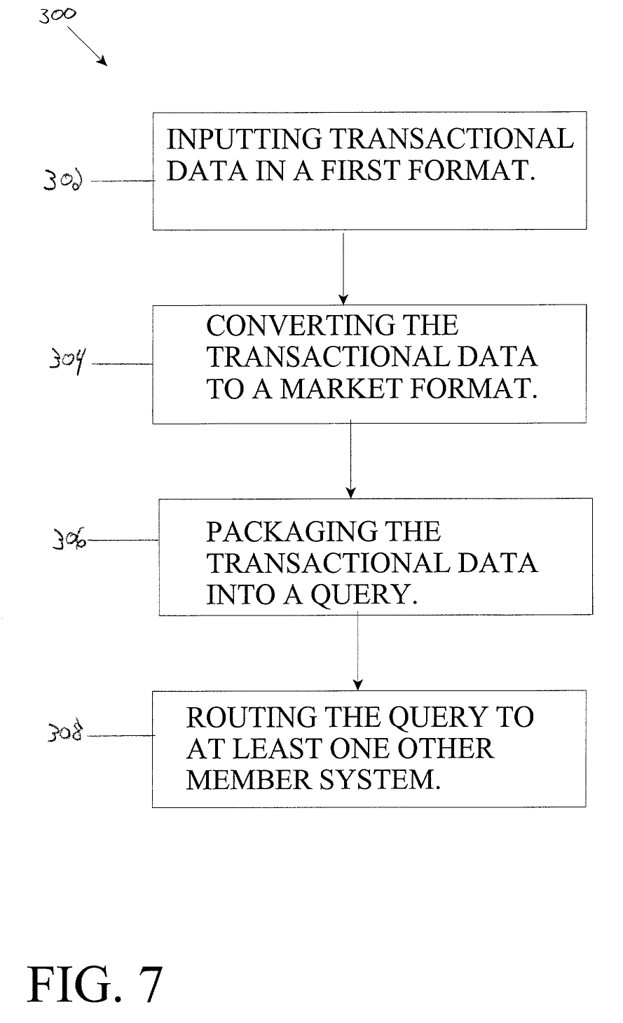

Referring now to FIG. 7, a method 300 in accordance with the present invention is shown. The first step 302 of the method 300 is to input transactional data in a first format. The second step 304 is to convert the transactional data to a market format. The third step 306 is to package the transactional data into a query. The fourth step 308 is to route the query directly to at least one other member system.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. An electronic marketplace, comprising:
a plurality of member systems, wherein each member system includes a system for communicating transactional data with the other member systems;
a market administrator for supporting a transaction between a first member system and a second member system; and
wherein the transactional data communicated between member systems does not pass through the market administrator.

2. The electronic marketplace of claim 1, wherein each member system further comprises:
a member interface for inputting the transactional data in a first format;
a converting system for converting the transactional data between the first format and a market format;
a query generator for creating a query based on the transactional data; and
a router for routing the query to other member systems.

3. The electronic marketplace of claim 2, wherein the converting system also converts transactional data received from another member system from the market format to the first format.

4. The electronic marketplace of claim 2, wherein each member system further comprises:
an agent system for managing mobile agents;
an analysis system for analyzing a query received from another market system;
a market interface for communicating with the market administrator;
a planner for scheduling transactions;
a task manager for identifying other markets corresponding to a transaction;
a file sharing system for sharing files with other member systems; and
a contact management system for managing contacts.

5. The electronic marketplace of claim 4, wherein the analysis system analyzes the query based on previously determined transaction rules.

6. The electronic marketplace of claim 2, wherein the router includes mapping information for identifying other member systems in communication with the market administrator.

7. The electronic marketplace of claim 2, wherein the member system is in communication with an enterprise database that includes inventory and format information.

8. The electronic marketplace of claim 7, wherein the format information correlates product information in the first format with the market format.

9. The electronic marketplace of claim 1, wherein the market administrator further comprises:
a system for accepting new member systems;
a transaction clearing system for clearing completed transactions;
a financial system for managing transaction finances;
a security system for maintaining member system security;
a rule and agent management system for managing mobile agents; and
a mobile messaging system for providing wireless access to the market administrator.

10. A system for conducting transactions within an electronic marketplace including at least one member system, each member system comprising:
a member interface for inputting transactional data in a first format;
a converting system for converting transactional data between the first format and a market format;
a query generator for generating a query based on the transactional data; and
a routing system for directly communicating the query to at least one of a plurality of other member systems.

11. The system of claim 10, wherein each member system further comprises:
a task manager for identifying other member systems necessary to complete a transaction;
a market interface for communicating with a market administrator; and
a database for storing a format information that correlates the first format to the market format.

12. The system of claim 11, wherein the converting system accesses the database to convert between the first format and the market format.

13. The system of claim 10, wherein the query generated is an SQL request query.

14. The system of claim 10, wherein the member interface is an XML interface.

15. The system of claim 10, wherein the routing system includes mapping information corresponding to other member systems.

16. The system of claim 10 further comprising a market administrator, wherein the market administrator includes:
a transaction clearing system for clearing completed between transactions member systems; and
a membership system for accepting new member systems.

17. A method for conducting transactions within an electronic marketplace, comprising the following steps:
inputting transactional data in a first format;
converting the transactional data into a market format;
packaging the transactional data into a query; and
routing the query directly to at least one other member system.

17. The method of claim 17, wherein the transactional data is inputted via a member interface.

18. The method of claim 17, wherein the step of converting the data into a market format comprises the step of accessing a database to correlate the first format to the market format.

19. The method of claim 17, wherein the query is an SQL request query, and wherein the member interface is an XML interface.

20. The method of claim 17, further comprising:
receiving a query containing transactional data from another member system in the market format; and
converting the transactional data from the market format to the first format.

21. A program product stored on a recordable media for conducting transactions within an electronic marketplace, comprising:
a member interface for inputting transactional data in a first format;
a converting system for converting all transactional data between the first format and a market format;
a query generator for generating a query based on the transactional data; and
a routing system for communicating the query directly to at least one of a plurality of other member systems.

22. The program product of claim 21, wherein the converting system accesses a database to correlates the first format to the market format.

23. The program product of claim 21, wherein the query generated is an SQL request query.

24. The program product of claim 21, wherein the member interface is an XML interface.

25. The program product of claim 21, wherein the routing system includes mapping information corresponding to other member systems.

26. The program product of claim 21, further comprising a market administrator for clearing completed transactions between member systems.

27. The program product of claim 21, wherein the product is written in Erlang.

28. An electronic marketplace, comprising:
a plurality of member routers each having at least one member system associated therewith, wherein each member router communicates directly with another member router based on routing information previously obtained from an administrator router.

29. The electronic marketplace of claim 28, wherein the electronic marketplace is a hypercube.

30. The electronic marketplace of claim 29, wherein each router system communicates with three other router systems.
